(19) United States
(12) Patent Application Publication
(10) Pub. No.: US 2015/0140334 A1
(43) Pub. Date: May 21, 2015

(54) MICROPARTICLE, PARTICULARLY A MICROPARTICLE FOR THE COUNTERFEIT-PROOF MARKING OF PRODUCTS

(71) Applicant: 3S Simons Security Systems GmbH, Nottuln (DE)

(72) Inventor: Rolf Simons, Nottuln (DE)

(21) Appl. No.: 14/408,742

(22) PCT Filed: Jul. 15, 2013
(86) PCT No.: PCT/EP2013/064927

§ 371 Date: Dec. 17, 2014

(30) Foreign Application Priority Data
Jul. 19, 2012 (EP) 12177183.6

(51) Int. Cl. C09D 5/00; C09D 167/03; G03H 1/00

(52) U.S. Cl. CPC C09D 5/00; G03H 1/0011; C09D 167/03
USPC 428/407; 359/2; 428/403; 427/7

(57) ABSTRACT

A microparticle, particularly a microparticle for the counterfeit-proof marking of products, wherein the microparticle comprises at least one first layer and at least one second layer. The first layer forms an external side of the microparticle and at least one mark preaffixed to this side is arranged at least on said external side, and wherein none of the dimensions of the microparticle exceed approximately 100 μm. A method is provided for producing at least one microparticle, tag and dispersion as well as a correspondent use.

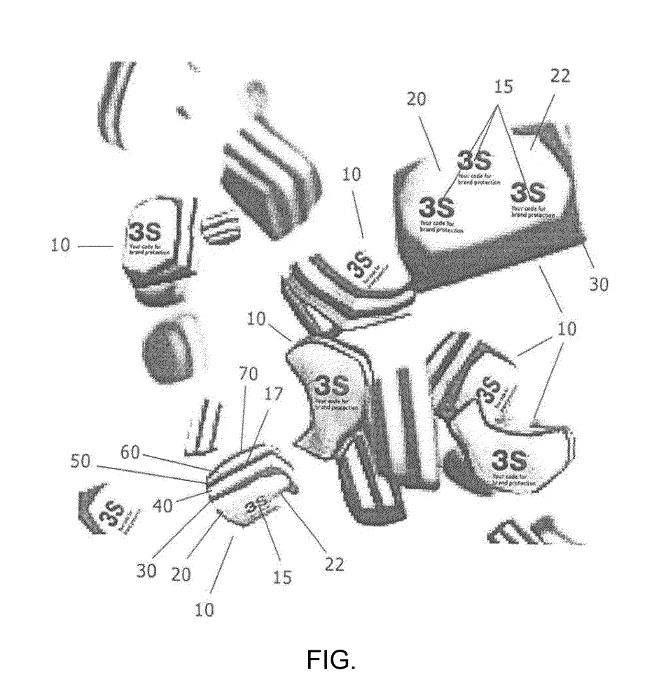

### CROSS-REFERENCES TO RELATED APPLICATIONS

This application claims the benefit of the European patent application No. 12177183.6 filed on Jul. 19, 2012, the entire disclosures of which are incorporated herein by way of reference.

### BACKGROUND OF THE INVENTION

The present invention relates to a microparticle, particularly a microparticle for the counterfeit-proof marking of products, a method for producing at least one microparticle, a tag, a dispersion and the use of, particularly, a microparticle for the counterfeit-proof marking of products.

Distinguishing authentic goods from counterfeit goods is an ever growing problem. This problem is particularly intensified by the fact that imitation or counterfeit goods are continually improving in quality, some now scarcely distinguishable from the original goods. Moreover, it is also observed that the current problem of product piracy and trademark counterfeiting no longer extends essentially just to imitation or counterfeit clothing, for example, but rather is also increasingly appearing in safety-critical fields such as e.g., replacement parts for motor vehicles and aircraft or even pharmaceutical products; i.e., counterfeit drugs.

The providing of counterfeit-proof identifiers of authentic goods is therefore increasingly gaining in significance.

DE 26 51 528 A1 discloses color-coded identifier microparticles to this effect consisting of a plurality of colored layers in a preselected color sequence, whereby the color sequence represents an identifying code. The microparticles are thereby produced from melamine alkyd resin, wherein seven colored layers are deposited one on top of each other on a 50.8 μm polyester carrier film at a thickness of 91.4 μm.

Microparticles of a uniform thickness of approximately 140 μm are further known from U.S. Pat. No. 4,390,452, whereby alphanumerics are deposited onto a surface of the microparticle after the plurality of layers have been joined together.

WO 2007/106512 A2 likewise discloses microparticles consisting of a plurality of layers additionally exhibiting different colors.

U.S. Pat. No. 6,952,994 B2 discloses an identification tag onto which a hologram is applied.

A method for producing multilayered microparticles is further known from EP 0 832 477 B1, wherein a plurality of marking layers are successively applied onto a sheet-shaped or web-shaped substrate, wherein each marking layer is applied in liquid state, and wherein a drying and/or hardening ensues following the application of each marking layer prior to the next marking layer being applied until a stack of layers is formed which has the desired type and sequence of marking layers, wherein the substrate and the layer stack are separated from each other in a subsequent step and the layer stack is crushed into multilayered microparticles while maintaining the entire sequence of marking layers.

A method for protecting and marking products using microparticles is further known from EP 1 003 146 B1. In this method, two or more differently coded microparticle groups are used for each product.

It would, however, be desirable to make the above-described identification systems even more secure, particularly with regard to even further improving counterfeiting security.

### SUMMARY OF THE INVENTION

It is therefore an objective of the present invention to advantageously further develop a microparticle, a method for producing such a microparticle, a tag, a dispersion as well as a corresponding use as cited at the outset, particularly to the effect of increasing counterfeiting security and at the same time facilitating and devising a more intuitive microparticle verification.

This objective is accomplished in accordance with the invention by a micro-particle, wherein the microparticle comprises at least one first layer and at least one second layer, wherein the first layer forms an external side of the microparticle and at least one preaffixed mark is disposed at least on this external side, and wherein the dimensions of the microparticle do not exceed approximately 100 μm.

It is in principle also conceivable that a mark is not only applied onto said external side of the first layer but rather additionally onto further external sides, at least one preaffixed mark being disposed on one further external side.

Doing so thus results particularly in the advantage of increasing counterfeiting security since it becomes more difficult to counterfeit the microparticle, firstly because of the affixed visual mark and secondly also because of the micro-particle's selected dimensions.

At the same time, verification of the microparticle is facilitated and devised so as to be more intuitive, particularly because a mark is now additionally applied to the external side of the microparticle, one which is visible for example using magnification means such as a magnifying glass or a pen microscope.

The microparticle can in particular be a microparticle for the counterfeit-proof marking of products. Such a microparticle for counterfeit-proof marking can for example be applied to a product, e.g., using a varnish. Alternatively, such a microparticle can also be affixed within a product, for example in a drill hole or by being inserted into the material of which the product at least partially consists. The microparticle can substantially comprise melamine alkyd polymers.

Because the marking is previously applied onto the first layer, the size advantage of less than approximately 100 μm being able to be achieved during the manufacturing of the microparticle ensues from the outset.

Due to the fact that none of the microparticle's dimensions exceed approximately 100 μm, the advantage in particular arises that it becomes difficult if not impossible to counterfeit the microparticles since counterfeiters would have to expend too great of an effort. The dimensions of the microparticle are in particular the length, width and depth of the microparticle which in each case do not exceed approximately 100 μm.

Since the microparticles preferably originate in a manufacturing process in which the microparticles result from crushing a multilayered layer structure, the micro-particles also exhibit a randomized shape and one or more break edges and/or cut edges.

The term preaffixed mark is to be interpreted broadly. It is in particular conceivable that in conjunction with the manufacturing step of crushing during the manufacturing of the microparticle, a preaffixed mark is only partially discernible, which however is to be regarded as utterly sufficient in the sense of the invention. It is in principle desirable and advantageous for at least one marking to be wholly visible, although this is not absolutely essential to realizing the invention. It is also possible to fully or partially provide a plurality of marks disposed on said external side.

It can moreover be provided for the microparticle to comprise at least one surface configured such that the overlapping layers are visible. Such a surface can for example be a break edge and/or cut edge or can be at least partly formed by a break edge and/or cut edge. The overlapping layers can form a coding, for example, which will be visible through the surface and thus visually verifiable or able to be verified.

It is furthermore feasible for none of the microparticle dimensions to exceed approximately 50 μm, preferably not exceed approximately 20 μm, particularly preferably not exceed approximately 8 μm. In a case in which none of the micro-particle dimensions exceed approximately 8 μm, the first layer can in particular be formed by a so-called transfer material. Such a transfer material can for example be a heat transfer, respectively an iron-on, or the like.

It is in principle conceivable that any size dimensions can be selected within the range of between approximately 8 μm to approximately 100 μm. It is thereby particularly advantageous for the at least one mark to remain completely visible on the external side of the first layer and the dimensions of the microparticle to be selected accordingly. It is thus conceivable for none of the dimensions of the microparticle to exceed approximately 100 μm, but also for none of its dimensions to fall below approximately 8 μm.

It is furthermore conceivable for the at least one mark to be at least a part of a hologram and/or an imprint, whereby the mark preferably comprises at least one letter, at least one part of a graphic symbol and/or at least one word/figurative mark, particularly a logo and/or trademark, or comprises another such mark. It is in particular advantageously conceivable for the mark used to identify authentic goods to always be the trademark of the original manufacturer.

It can additionally be provided for the first layer to be formed by a polyester film, particularly a PET film, whereby the polyester film, in particular the PET film, preferably exhibits a layer thickness ranging from between approximately 5 μm and 15 μm, preferably approximately 7 μm.

It is further possible for the second layer to be a colored layer.

At least one further layer applied to and/or disposed on the second layer can be advantageously further provided. This further layer can be a colored layer.

It is preferably conceivable to provide a plurality of further layers applied to and/or disposed on the second layer, whereby the further layers are preferably colored layers such that preferably the second layer and the further layers yield an arrangement of layers furnished so as to form a color code, wherein the layers preferably each have a layer thickness ranging from approximately 0.5 μm to approximately 15 μm, for example from between approximately 8 μm and 10 μm, preferably for producing small microparticles of approximately 0.8 μm.

Said color code can be provided such that it can be uniquely assigned to one manufacturer and/or one product. It is conceivable for the color code to be constructed from a layer structure of from five to twelve layers. Preferably ten or eleven layers is selected for the number of layers so as to achieve a satisfactory coding possibility.

In one case in which the color code is constructed from a layer structure of up to twelve layers, the first of the twelve layers can be a layer with at least one preaffixed mark, the further second to eleventh layers colored layers, and the twelfth layer again a layer having at least one preaffixed mark.

The present invention furthermore relates to a method for producing at least one microparticle. According thereto, it is provided in a method for producing at least one microparticle, particularly a microparticle for the counterfeit-proof marking of products, for at least one second layer to be initially applied to at least one first layer, wherein the first layer forms an external side of the microparticle and at least one preaffixed mark is disposed on said external side, and wherein the at least one first layer and at least one second layer are crushed into microparticles, whereby the microparticle dimensions do not exceed approximately 100 μm.

It can in particular be provided for the first layer to be formed by a polyester film, particularly PET film, whereby preferably the polyester film, or particularly the PET film respectively, exhibits a layer thickness ranging between approximately 5 μm and 15 μm, preferably of approximately 7 μm.

It is further conceivable for the second layer to be a colored layer and/or for at least one further layer, preferably a plurality of further layers, to be provided which are preferably applied onto and/or arranged on the second layer, wherein the further layers are preferably colored layers such that the second layer and the further layers preferably yield an arrangement of layers provided such that the layers form a color code, wherein the layers preferably each have a layer thickness ranging from approximately 0.5 μm to approximately 50 μm, e.g., from between approximately 8 μm and 10 μm, preferably for producing small microparticles of approximately 0.8 μm.

The procedure in producing the microparticles is for example such that the at least one second layer or plurality of layers respectively is/are successively deposited on the first layer serving as the substrate layer. The further layers can be colored layers, particularly marking layers. These marking layers can for example be applied in liquid form.

A drying and/or hardening can further follow the application of each marking layer prior to the next marking layer being deposited. This process is continued until a stack of layers having the desired type and sequence of marking layers is formed.

The stack of layers is thereafter crushed into multilayered microparticles while maintaining the entire sequence of marking layers.

The individual marking layers are thereby applied in a printing process, wherein a relief printing or rotogravure or planographic or screenprinting process, silkscreen process respectively, can preferably be used.

It is in principle also conceivable for each marking layer to be deposited in paste form instead of in liquid form. It is in particular conceivable in this context for each marking layer to be applied in a thixotropic state.

It is in particular also possible to use glass powder and/or enamel powder with added heat-resistant pigments as the base substance for the marking layers and for this base substance to be brought into a paste form prior to application by the addition of transfer varnish or printing oil.

It is conceivable that instead of liquid or paste form, each marking layer can also be deposited in a dry state in powder form by means of a bronzing process. In this context, it is particularly conceivable to use glass powder and/or enamel powder with added heat-resistant pigments as the base substance for the marking layers.

It is moreover conceivable for the individual marking layers to be applied by means of a spray coating process. Drawing on a roller coating process is also conceivable for the application of the individual marking layers.

It is particularly advantageous for the stack of layers formed on the first layer; i.e., the substrate layer comprising the marking layers, to be dried and/or hardened and/or annealed prior to being crushed. Drying and hardening can thereby be realized using heat and/or UV radiation. This step of drying and/or hardening and/or annealing is expedient in order to lend mechanical properties which are beneficial with respect to the crushing to the individual layers themselves and to the stack of layers prior to the subsequent crushing of the layer stack into the individual microparticles. What this thereby in particular achieves is relatively high brittleness simultaneously coupled with good stability and strong cohesion to the layers.

The layer stack can be crushed in known manner, e.g., in suitable mills such as a ball mill, for example. In order to enable the unequivocal identification of the material or objects marked with the microparticles, the crushing is expediently effected only to the extent that the majority of the thereby respectively resulting microparticles still contain the entire marking layer sequence. A sorting of the microparticles can additionally occur after the crushing process, whereby those microparticles which no longer have the full sequence of marking layers and/or the complete marking can be sorted out so as to exclude their further use for marking purposes.

The size of the microparticles is thereby advantageously selected in a range of between approximately 8 μm and approximately 100 μm since this range in any case ensures that at least one marking is recognizable on the external side of the substrate layer.

The present invention further relates to a tag. According thereto, it is provided for a tag to comprise at least one microparticle. The term tag is to be understood in broad terms. In the present context, a tag can also be a transfer (particularly an iron-on or heat transfer) or a decal.

The present invention additionally relates to a dispersion. According thereto, it is provided for a dispersion to contain at least one microparticle. The dispersion can in particular be a varnish or a coloring containing for example one or more microparticles. Preferably a plurality of microparticles are dispersed in the dispersion. The dispersion is thereby preferably transparent, e.g., a clear varnish or the like such as, for example, a transparent resin or a transparent adhesive.

Further details and advantages of the invention are now to be described in greater detail on the basis of an embodiment depicted in the FIGURE.

### BRIEF DESCRIPTION OF THE DRAWINGS

The sole FIGURE shows a plurality of microparticles pursuant the present invention.

### DETAILED DESCRIPTION OF THE PREFERRED EMBODIMENTS

As the FIGURE shows, the microparticles 10 are not identical as a result of the crushing process, their shapes instead being randomized; i.e., the particle shapes are random and not predefined.

The microparticles 10 serve in the counterfeit-proof marking of products and thereby comprise a first layer 20 onto which the further layers 30, 40, 50, 60, 70 are applied in the manufacturing process. The first layer 20 is thus a substrate layer 20.

The layers 30, 40, 50, 60, 70 are thereby colored layers applied onto the substrate layer 20.

The first layer 20, or substrate layer 20 respectively, forms an external side 22 of the microparticle 10. At least one mark 15, here a logo 14 or a company's trademark 15 respectively, is disposed on said external side 22. This mark 15 has thereby already been applied to or deposited on the layer 20 previously.

The layer 20 can in particular be a carrier film, particularly a polyester film or a PET film respectively. The mark 15 can thereby be imprinted or otherwise applied to the carrier film. It is in principle also conceivable for the mark 15 to be applied onto the substrate layer 20 as nanoscale lettering. It is for example conceivable for the font size or the character height to amount to 1 nm or more.

It is further conceivable for the side 22 of the substrate layer 20 to exhibit a plurality of marks 15 in the form of holograms or imprints.

The microparticles 10 are thereby provided in such a manner that none of the dimensions of said microparticles 10 exceed approximately 100 μm, preferably 50 μm, particularly preferentially 8 μm. In the embodiment shown in the FIGURE, the selected dimensions of the microparticles 10 range from between approximately 8 μm and approximately 100 μm, wherein these lower and upper limits are however not undercut or exceeded.

The layers 30, 40, 50, 60, 70 are colored layers, in the present case for example a red colored layer 30, a white colored layer 40, a blue colored layer 50, another white colored layer 60 and a black colored layer 70.

The microparticles 10 further exhibit at least one surface 17 which is configured such that the colored layers 30, 40, 50, 60, 70 lying atop one another are visible. The surface 17 is a lateral surface 17 resulting from the crushing process during the manufacturing of the microparticle 10; i.e., essentially a cut edge or a break edge, for example.

The arrangement of the colorings or colored layers 30, 40, 50, 60, 70 respectively forms a color code which, in combination with the mark 15, here for example the trademark of a company, jointly forms a counterfeit-proof code. This code can be readily verified, for example using an incident light and/or pen microscope.

The microparticles 10 can thereby be inserted into a tag or deposited onto a tag, for example by means of a dispersion such as for example a clear varnish or the like such as a transparent resin or a transparent adhesive.

It is in principle also conceivable for the microparticles 10 to be dispersed in a dispersion, such as e.g., a coloring or a varnish, and thus applied directly onto the product to be marked.

To produce the microparticles 10, the procedure ensues with the layers 30, 40, 50, 60, 70 being successively deposited onto the first layer 20 acting as a substrate layer, whereby the marking layers 30, 40, 50, 60, 70 are preferably deposited in liquid form and whereby a drying and/or hardening follows the application of each marking layer 30, 40, 50, 60, 70 prior to the next marking layer 30, 40, 50, 60, 70 being deposited. This process is continued until a stack of layers having the desired type and sequence of marking layers is formed.

The layer stack is thereafter crushed into multilayered microparticles 10 while maintaining the full sequence of marking layers.

The individual marking layers are thereby applied by means of a printing process, wherein a relief printing or rotogravure or planographic or screenprinting process, silkscreen process respectively, can preferably be used.

It is in principle also conceivable for each marking layer 30, 40, 50, 60, 70 to be deposited in paste form instead of liquid form. It is in particular conceivable in this context for each marking layer 30, 40, 50, 60, 70 to be applied in a thixotropic state. It is in particular also possible to use glass powder and/or enamel powder with added heat-resistant pigments as the base substance for the marking layers 30, 40, 50, 60, 70 and for this base substance to be brought into a paste form prior to application by the addition of transfer varnish or printing oil.

It is conceivable that instead of being in liquid or paste form, each marking layer 30, 40, 50, 60, 70 can also be deposited in a dry state in powder form by means of a bronzing process. In this context, it is particularly conceivable to use glass powder and/or enamel powder with added heat-resistant pigments as the base substance for the marking layers 30, 40, 50, 60, 70.

It is moreover conceivable for the individual marking layers to be applied by means of a spray coating process. Drawing on a roller coating process is also conceivable for the application of the individual marking layers 30, 40, 50, 60, 70.

It is particularly advantageous when the layer stack formed on the substrate layer 20 comprising the marking layers 30, 40, 50, 60, 70 is dried and/or hardened and/or annealed prior to being crushed. Drying and hardening can thereby be preferentially realized using heat. This step of drying and/or hardening and/or annealing is expedient in order to lend mechanical properties which are beneficial with respect to the crushing to the individual layers themselves and to the stack of layers prior to the subsequent crushing of the layer stack into the individual microparticles 10. What this in particular thereby achieves is relatively high brittleness simultaneously coupled with good stability and strong cohesion to the layers 20, 30, 40, 50, 60, 70.

The layer stack can be crushed in known manner, e.g., in suitable mills such as a ball mill, for example. In order to enable the unequivocal identification of the material or objects marked with the microparticles 10, the crushing is expediently effected only to the extent that the majority of the thereby respectively resulting microparticles 10 still contain the entire marking layer sequence. A sorting of the microparticles 10 can additionally occur after the crushing procedure, whereby those microparticles which no longer have the full sequence of marking layers and/or a complete marking 15 can be sorted out so as to exclude their further use for marking purposes.

The size of the microparticles 10 is thereby advantageously selected in a range of between approximately 8 μm and approximately 100 μm since this range in any case ensures that at least one marking 15 is recognizable on the external side 22 of the substrate layer 20.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-15. (canceled)

16. A microparticle comprising:
at least one first layer and
at least one second layer,
the first layer forming an external side of the microparticle,
at least one mark preaffixed to the external side being arranged at least on said external side, and
none of a height, width and thickness dimension of the microparticle exceed approximately 100 μm.

17. The microparticle according to claim 16, further comprising at least one surface configured such that the overlapping layers are visible.

18. The microparticle according to claim 16, wherein none of the dimensions of the microparticle exceed approximately 50 μm.

19. The microparticle according to claim 16, wherein none of the dimensions of the microparticle exceed approximately 20 μm.

20. The microparticle according to claim 16, wherein none of the dimensions of the microparticle exceed approximately 8 μm.

21. The microparticle according to claim 16, wherein the at least one mark comprises at least a part of one of a hologram and an imprint, and wherein the mark is selected from the group consisting of at least one letter, at least one part of a graphic symbol, at least one word, at least one figurative mark, a logo and a trademark.

22. The microparticle according to claim 16, wherein the first layer is formed by a polyester film having a layer thickness ranging from between approximately 5 μm and 15 μm.

23. The microparticle according to claim 22, wherein the polyester film comprises PET.

24. The microparticle according to claim 22, wherein the polyester layer has a layer thickness of approximately 7 μm.

25. The microparticle according to claim 16, wherein the second layer is a colored layer.

26. The microparticle according to claim 16, wherein at least one further layer is provided, wherein the further layer is a colored layer having a thickness ranging from approximately 0.5 μm to approximately 50 μm.

27. The microparticle according to claim 16, wherein a plurality of further layers are provided, wherein the further layers are colored layers such that the further layers yield an arrangement of layers furnished such that said layers form a color code, wherein the layers preferably each have a layer thickness ranging from approximately 0.5 μm to approximately 50 μm.

28. A method for producing at least one microparticle, comprising the steps:
initially applying at least one second layer to at least one first layer, the first layer forming an external side of the microparticle,
preaffixing at least one mark to the external side, and
crushing the at least one first layer and at least one second layer into microparticles, wherein none of the microparticle height, length and thickness dimensions exceed approximately 100 μm.

29. The method according to claim 28, wherein the first layer is formed by a polyester film having a layer thickness ranging from between approximately 5 μm and 15 μm.

30. The method according to claim 28, wherein the at least one second layer comprises a plurality of colored layers, such that the plurality of colored layers yield an arrangement of layers provided such that the layers form a color code, wherein the colored layers preferably each have a layer thickness ranging from approximately 0.5 μm to approximately 50 μm.

31. A microparticle obtained by a method in accordance with claim 28.

32. A tag comprising at least one microparticle according to claim 16.

33. A dispersion containing at least one microparticle according to claim 16.

34. The use of a microparticle according to claim 61 in association with a product to document an authenticity of the product.
